(19) United States
(12) Patent Application Publication
(10) Pub. No.: US 2020/0344293 A1
(43) Pub. Date: Oct. 29, 2020

(54) DISTRIBUTED ROBOTIC CONTROLLERS

(71) Applicant: Google LLC, Mountain View, CA (US)

(72) Inventors: Steve Wolter, Munich (DE); Damon Kohler, Munich (DE); Julius Kammerl, Munich (DE); David Schmidt, Munich (DE); Thomas Larkworthy, Berlin (DE)

(21) Appl. No.: 16/391,447

(22) Filed: Apr. 23, 2019

(51) Int. Cl. H04L 29/08; G06F 16/27; G06F 16/23; B25J 9/16

(52) U.S. Cl. CPC H04L 67/1095; H04L 67/1097; B25J 9/161; G06F 16/275; G06F 16/2379; H04L 67/34

(57) ABSTRACT

The technology provides for a robotic control system implemented on a distributed system, which may include at least one processor on a cloud computing system and at least one processor on a robot. For instance, configuration data for a plurality of controllers of the robot may be received and the plurality of controllers may be deployed on the distributed system. For example, a first controller may be deployed on the cloud while a second controller may be deployed on the robot. The system may include a cloud database and a robot database. Both databases may store configuration data and current states of the first controller and the second controller, and may be synchronized. Workload for the first controller and the second controller may both be controlled based on the configuration data and the current states of the first controller and the second controller.

### BACKGROUND

A robotic control system typically includes a hierarchy of controllers working in a message-driven scheme. Based on messages from higher controllers, the lower level controllers may actuate components of the robot accordingly. To monitor progress, the higher level controllers may monitor the states of the lower level controllers. The controllers may continue to pass messages until tasks are completed. Robots, however, often operate in environments with poor and intermittent network connectivity, which may cause some of the messages to be lost and therefore impacting performance of the robots.

A cloud computing system makes available to a user a large amount of processing power and storage resources via networked computing devices. Items on a cloud computing system may be replicated to protect against failure events, such as intermittent network connectivity.

### BRIEF SUMMARY

The present disclosure provides for receiving, by one or more processors in a distributed system, configuration data for a plurality of controllers of a robot, wherein the distributed system includes at least one processor on a cloud computing system and at least one processor on the robot, and wherein the configuration data includes desired states for the plurality of controllers; deploying, by the one or more processors, the plurality of controllers on the distributed system, wherein a first controller of the plurality of controllers is deployed on one or more processors on the cloud computing system and a second controller of the plurality of controllers is deployed on one or more processors on the robot; synchronizing, by the one or more processors, a cloud database on the cloud computing system with a robot database on the robot, the cloud database and the robot database store configuration data and current states of the first controller and configuration data and current states of the second controller; controlling, by the one or more processors, workload for the first controller based on the configuration data and the current states of the first controller and the configuration data and current states of the second controller; and controlling, by the one or more processors, workload for the second controller based on the configuration data and the current states of the first controller and the configuration data and the current states of the second controller.

The method may further comprise generating, by the one or more processors, a first master node on the cloud computing system, the first master node including the cloud database; generating, by the one or more processors, a second master node on the robot, the second master node including the robot database.

The method may further comprise generating, by the one or more processors, a plurality of worker nodes on the cloud computing system, wherein the first master node controls the worker nodes on the cloud computing system to perform the workload for the first controller; generating, by the one or more processors, a plurality of worker nodes on the robot, wherein the second master node controls the worker nodes on the robot to perform the workload for the second controller.

The method may further comprise receiving, by the one or more processors, statuses from the worker nodes on the cloud computing system; updating, by the one or more processors, the cloud database with the received statuses; comparing, by the one or more processors, the desired states of the first controller with the received statuses; controlling, by the one or more processors, workload of the worker nodes on the cloud computing system based on the comparison. The method may further comprise receiving, by the one or more processors, statuses from the worker nodes on the robot; updating, by the one or more processors, the robot database with the received statuses; comparing, by the one or more processors, the desired states of the second controller with the received statuses; controlling, by the one or more processors, workload of the worker nodes on the robot based on the comparison.

The method may further comprise receiving, by the one or more processors, a first message from the first controller, the first message includes an intent for the second controller; updating, by the one or more processors, the cloud database with the intent for the second controller; synchronizing, by the one or more processors, the robot database with the updated cloud database, the synchronized robot database includes the intent for the second controller; accessing, by the one or more processors, the intent for the second controller stored on the robot database; controlling, by the one or more processors, workload for the second controller based on the intent for the second controller. The method may further comprise prior to updating the cloud database, translating, by the one or more processors, the first message from a programming language of the first controller into a programming language of the cloud database. The method may further comprise prior to controlling the workload for the second controller, converting, by the one or more processors, a poll based interface for accessing the robot database to a request based interface for interacting with the second controller.

The method may further comprise receiving, by the one or more processors, a second message from the second controller, the second message reporting a status of the second controller; updating, by the one or more processors, the robot database with the status for the second controller; synchronizing, by the one or more processors, the cloud database with the updated robot database, the synchronized cloud database includes the status for the second controller; accessing, by the one or more processors, the status for the second controller stored on the cloud database; controlling, by the one or more processors, workload for the first controller based on the statues for the second controller.

The first message may conform to rules defined by a declarative API, the declarative API being defined in a repository of the distributed system. The declarative API may be independent of programming language. The declarative API may include a progress field with standardized codes, and wherein the first controller is configured to send messages for controlling unknown capabilities of the second controller based on the standardized codes.

The configuration data may further include definitions for a plurality of resources each of the plurality of controllers can manipulate to perform workload.

The method may further comprise obtaining, by the one or more processors, a first lease for the first controller for manipulating a resource of the plurality of resources, the first lease including a deadline, wherein other controllers of the plurality of controllers cannot manipulate the resource while being leased to the first controller. The method may further comprise obtaining, by the one or more processors, a first lease for the first controller for manipulating a resource of the plurality of resources, the first lease including a first priority level; breaking, by the one or more processors, the first lease held by the first controller, wherein another controller of the plurality of controllers holds a second lease for the resource with a second priority level higher than the first priority level.

The method may further comprise generating, by the one or more processors, a conflict-resolving resource, the conflict-resolving resource including a resource, at least two requests to manipulate the resource from at least two of the plurality of controllers, and a priority level for each of the requests; generating, by the one or more processors, a conflict-resolving controller, the conflict resolving controller configured to select a request among the requests with a highest priority level, manipulate the resource based on the selected request, and pass the manipulated resource to another controller of the plurality of controllers for actuation.

The plurality of resources may include only one resource of a type to be used by the plurality of controllers of the robot, each of the resources may include a current action to be executed and identifies a controller of the plurality of controllers for execution.

The method may further comprise monitoring, by the one or more processors, changes in the current states for the first controller and changes in the current states for the second controller; generating, by the one or more processors, a log including in the current states for the first controller and changes in the current states for the second controller.

The present disclosure further provides for a system comprising a plurality of processors in a distributed system including at least one processor on a cloud computing system and at least one processor on a robot, the plurality of processors configured to: receive configuration data for a plurality of controllers of a robot, the configuration data including desired states for the plurality of controllers; deploy the plurality of controllers on the distributed system, wherein a first controller of the plurality of controllers is deployed on one or more processors on the cloud computing system and a second controller of the plurality of controllers is deployed on one or more processors on the robot; synchronize a cloud database on the cloud computing system with a robot database on the robot, the cloud database and the robot database store configuration data and current states of the first controller and configuration data and current states of the second controller; control workload for the first controller based on the configuration data and the current states of the first controller and the configuration data and current states of the second controller; and control workload for the second controller based on the configuration data and the current states of the first controller and the configuration data and the current states of the second controller.

The present disclosure still further provides for a computer-readable storage medium storing instructions executable by one or more processors for performing a method, comprising: receiving configuration data for a plurality of controllers of a robot, wherein the configuration data includes desired states for the plurality of controllers; deploying the plurality of controllers on a distributed system, wherein a first controller of the plurality of controllers is deployed on one or more processors on a cloud computing system and a second controller of the plurality of controllers is deployed on one or more processors on the robot; synchronizing a cloud database on the cloud computing system with a robot database on the robot, the cloud database and the robot database store configuration data and current states of the first controller and configuration data and current states of the second controller; controlling workload for the first controller based on the configuration data and the current states of the first controller and the configuration data and current states of the second controller; and controlling workload for the second controller based on the configuration data and the current states of the first controller and the configuration data and the current states of the second controller.

### BRIEF DESCRIPTION OF THE DRAWINGS

FIG. 1 is a block diagram illustrating an example robotic control system in accordance with aspects of the disclosure.

FIG. 2 is a block diagram illustrating an example distributed system in accordance with aspects of the disclosure.

FIG. 3 is a block diagram illustrating an example container orchestration architecture in accordance with aspects of the disclosure.

FIGS. 4A-4B illustrate example code in accordance with aspects of the disclosure.

FIGS. 5A-5C illustrate example timing diagrams in accordance with aspects of the disclosure.

FIG. 6 is a flow diagram in accordance with aspects of the disclosure.

### DETAILED DESCRIPTION

### Overview

The technology generally relates to implementing a robotic control system on a distributed system. Message-driven systems of a robot may have a number of drawbacks. For example, the back-and-forth messages typically are stored only in the memories associated with the sender and/or recipient controllers. As such, in case of memory failure or reset (such as due to intermittent network connectivity or software update) at the sender and/or recipient controllers, information in these messages may not be recovered. For another example, two controllers may send messages with conflicting instructions to a low level controller, but the two controllers may not be aware of each other's conflicting instructions. Still further, since the messages may include incremental instructions (such as move a bit more to the left), debugging may require inspection of all previous messages, which may be time-consuming and labor intensive. In order to resolve these issues, a robotic control system is provided on a distributed system with synchronized databases.

In this regard, the distributed system may include at least one processor on a cloud computing system and at least one processor on a robot (or on a fleet of robots). Configuration data for a plurality of controllers of the robot may be received, for example, from a user, such as a developer attempting to control the robot to complete various tasks. For instance, the configuration data may include desired states for the plurality of controllers of the robot. The desired states may include any of a number of tasks, such as move to a target position, pick up a box, etc.

The plurality of controllers may be deployed on the distributed system. For instance, a first controller of the plurality of controllers may be deployed on one or more processors on the cloud computing system. For another instance, a second controller of the plurality of controllers may be deployed on one or more processors on the robot. In some instances, higher-level controllers of the robot may be deployed on the cloud, while the lower-level controllers of the robot may be deployed on the robot. The controllers may interact with each other through declarative APIs, which may define message format and other rules for the controllers.

The distributed system may maintain a plurality of databases. For instance, a cloud database may be maintained on the cloud and a robot database may be maintained on the robot. For example, the cloud database and the robot database may both store configuration data and current states of the first controller and configuration data and current states of the second controller. The cloud database and the robot database may be synchronized such that the robotic control system may keep track of the states of its various controllers. In this regard, high availability of the cloud database may protect the control system from memory failures and/or resets.

Workload for the plurality of controllers may be controlled based on the information stored in the databases. For example, where a first controller is directly above a second controller in a control hierarchy, workload for the first controller may be controlled based on the configuration data and the current states of the first controller and the configuration data and current states of the second controller. Likewise, workload for the second controller may be based on the configuration data and the current states of the first controller and the configuration data and the current states of the second controller.

In some examples, the distributed system may be configured with additional features. For example, the distributed system may be deployed using a containerized architecture. The distributed system may be provided with adaptors for translating programming languages, and/or for converting between different types of communication interfaces. The distributed system may be configured to use various conflict-resolving mechanisms. The distributed system may be configured to support multiple versions of APIs through which the controllers may communicate. The distributed system may be configured to generate a log of desired states and/or current states using the synchronized databases for debugging purposes.

The technology is advantageous because a distributed system is provided for robotic control that insulates business logic of a robot from network latency and intermittent connectivity. Using a communication layer implemented through declarative APIs on a cloud system, controllers of a robot may send messages to each other and be ensured that information in the messages are stored and updated in a cloud database. The technology also provides for conflict resolution mechanisms that may improve performance of robots. Features of the technology further provide for translation of messages between different programming languages, and conversion between different types of communication interfaces, thus reducing the need to completely re-program the database and/or the controllers. Further, the distributed system may generate consistent logs for the system using the synchronized database, which facilitates debugging.

### Example Systems

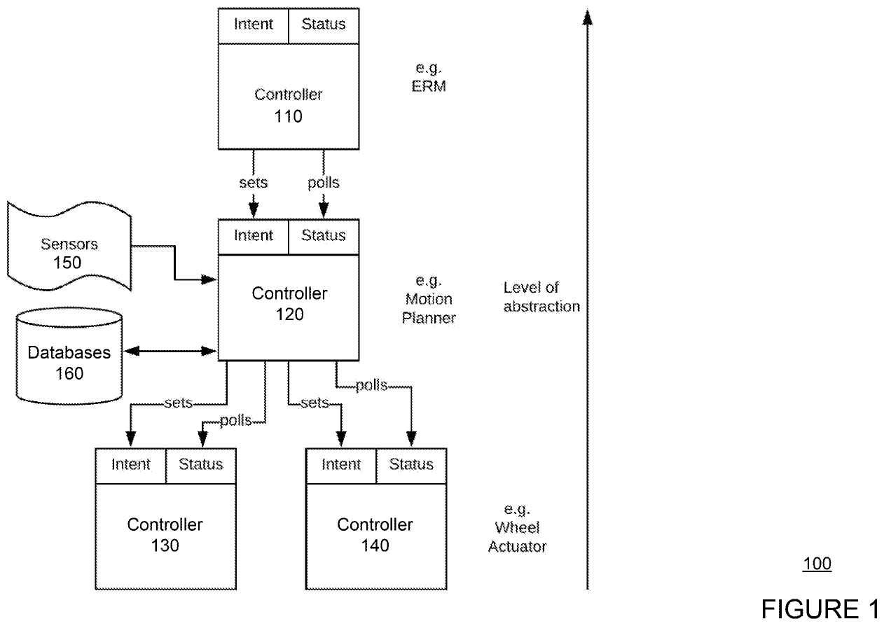

FIG. 1 is a block diagram illustrating an example robotic control system 100. The robotic control system 100 may be configured to control any of a number types of robotic and/or mobile devices, such as industrial robots, medical robots, autonomous vehicles, drones, home assistants, etc. As shown, the robotic control system 100 includes one or more controllers, such as controllers 110, 120, 130, 140, one or more sensors 150, and one or more databases 160. The controllers of the robotic control system 100 may be configured as a hierarchy. For instance, controller 110 may be a high-level controller, controller 120 may be a mid-level controller, and controllers 130 and 140 may be low-level controllers. The controllers may be configured to communicate with each other in order to control one or more robots to complete various tasks. By way of example only, the high-level controller 110 may be an Enterprise Resource Management controller of a warehouse that manages a fleet of robots for completing various tasks. By way of another example, the high-level controller 110 may receive via a user interface an input from a user (e.g., a worker in the warehouse) including high-level commands. The mid-level controller 120 may be a motion planner for a particular robot. The low-level controllers 130, 140 may be configured to actuate mechanical and/or electrical components of the robot.

Continuing the warehouse example, the Enterprise Resource Management controller (high-level controller 110) may be configured to determine tasks that need to be completed by the fleet in the warehouse, such as “picking up a box from shelf A.” For example, the high-level controller 110 may also be configured to determine availabilities of various robots in the fleet for completing the task, and to select an available robot for the task. The high-level controller 110 may be configured to send a message to the mid-level controller 120 that controls the selected robot.

The mid-level controller 120 may be, for example, a motion planner of the selected robot. For example, the message may “set” a desired state or “intent” of the mid-level controller 120 to “picking up a box from shelf A.” The mid-level controller 120 may be configured to receive sensor data from one or more sensors 150 in order to determine a current state, such as a current position, of the robot. Based on the current position, the mid-level controller 120 may be configured to determine a route for the robot in order to reach shelf A. The mid-level controller 120 may be configured to send one or more messages including instructions based on the determined route to one or more low-level controllers, such as low-level controllers 130 and 140.

The low-level controllers 130 and 140 may be, for example, a wheel actuator and an arm actuator, respectively. For instance, the mid-level controller 120 may send a message to the low-level controller 130 that sets an intent of the low-level controller 130 to “rotate wheels 3 times.” For another instance, the mid-level controller 120 may also send a message to the low-level controller 130 that sets an intent of the low-level controller 140 to “extend arm.”

The low-level controllers 130, 140 may be configured to actuate mechanical and/or electrical components of the robot. For example, low-level controller 130 may actuate the wheels to rotate in order to reach shelf A, and the low-level controller 140 may actuate the arm to extend in order to pick up a box from shelf A. In this regard, though not shown, the robot may include any of a number of electrical and/or mechanical components needed for completing various tasks, such as wheels, motors, lights, input/output devices, position determining modules, clocks, etc.

Controllers of the robotic control system 100 may be configured to monitor progress of various tasks being completed by one or more robots or components. For instance, the mid-level controller 120 may be configured to “poll” the low-level controllers 130 and/or 140 for their current states or “status.” In response to the poll, the mid-level controller 120 may receive a message from the low-level controller 130 including a status indicating whether the wheels had been rotated three times, and/or a message from the low-level controller 140 including a status indicating whether a box had been picked up. Based on the statuses, sensor data from sensors 150, and/or information from databases 160, the mid-level controller 120 may determine whether to set a new intent for the low-level controllers 130 and/or 140. For example, based on a status indicating that the wheels had been rotated three times, a status indicating that the arm has been extended, and a current position based on sensor data, the mid-level controller 120 may set a new intent as “retract the arm” for the low-level controller 140.

Likewise, the high-level controller 110 may be configured to “poll” the mid-level controller 120 for its status. For instance, in response to the poll, the high-level controller 110 may receive a message from the mid-level controller 120 including a status indicating a current position of the robot, whether a box had been picked up, etc. Based on the statuses, the high-level controller 110 may determine whether to set a new intent for the mid-level controller 120. For example, based on a status indicating that the current position of the robot is at shelf A and a status indicating that a box had been picked up, high-level controller 110 may set a new intent as “pick up a box from shelf B” for the mid-level controller 120.

Thus, as shown in FIG. 1, controllers of a robot and, on a larger scale, controllers of a fleet of robots, may form a distributed system of controllers. For instance, some of the controllers may be implemented on different processors. Although FIG. 1 shows only a few controllers in a three-level hierarchy, this distributed robotic control system 100 may include many controllers in a hierarchy having any number of levels. For example, the robotic control system 100 may be configured with one or more additional layers of controllers between the high-level controller 110 and the mid-level controller 120, or between the mid-level controller 120 and the low-level controllers 130, 140.

Further as described above, the distributed controllers in the robotic control system 100 rely on a message-driven system, which may have a number of drawbacks. For example, if the back-and-forth messages are stored only in the memories associated with the sender and/or recipient controllers, only the high-level controller 110 and the mid-level controller 120 may share a memory state regarding the intent “picking up a box for shelf A,” while the low-level controllers 130 and 140 may not be aware of this intent. As such, in case of memory failure or reset (e.g., due to intermittent network connectivity or software update) at the high-level controller 110 and/or mid-level controller 120 causing this intent to be lost, the robot may no longer know why its wheels are being rotated by the low-level controller 130 or its arms are extended by low-level controller 140. For another example, if a second mid-level controller (not shown) sends a message setting a conflicting new intent to the low-level controller 130, such as an emergency stop, the low-level controller 130 may execute the stop, but the first mid-level controller 120 may not know of this new intent. Still further, since the messages may include incremental instructions (e.g., move a bit more to the left), debugging may require inspection of all previous messages, which may be time-consuming and labor intensive.

In order to resolve these issues, the one or more databases 160 may be configured to store and update the current states of the robotic control system 100, such as intents and statuses of the controllers in the robotic control system 100. Controllers in the robotic control system 100 may be configured to access the states stored in the database to control the robot. As such, in case of intermittent connectivity or failure at one of the controllers which may cause loss of the intents and statuses at the controller, other controllers and the failed controller upon recovery may be configured to access the databases 160 for the lost intents and statuses. To further protect the system from memory loss, the databases 160 may include one or more databases implemented on a cloud computing system. Still further, in some instances the one or more databases 160 may include both databases implemented on the cloud computing system and locally implemented on the robot, which may be synchronized to maintain a consistent record of the intents and states of the controllers. Additionally, the databases 160 may be further configured to store any other type of additional information, such as reference information (e.g., maps, images, information on other robots, etc.), which may be accessed by the controllers 110, 120, 130, 140 during operation.

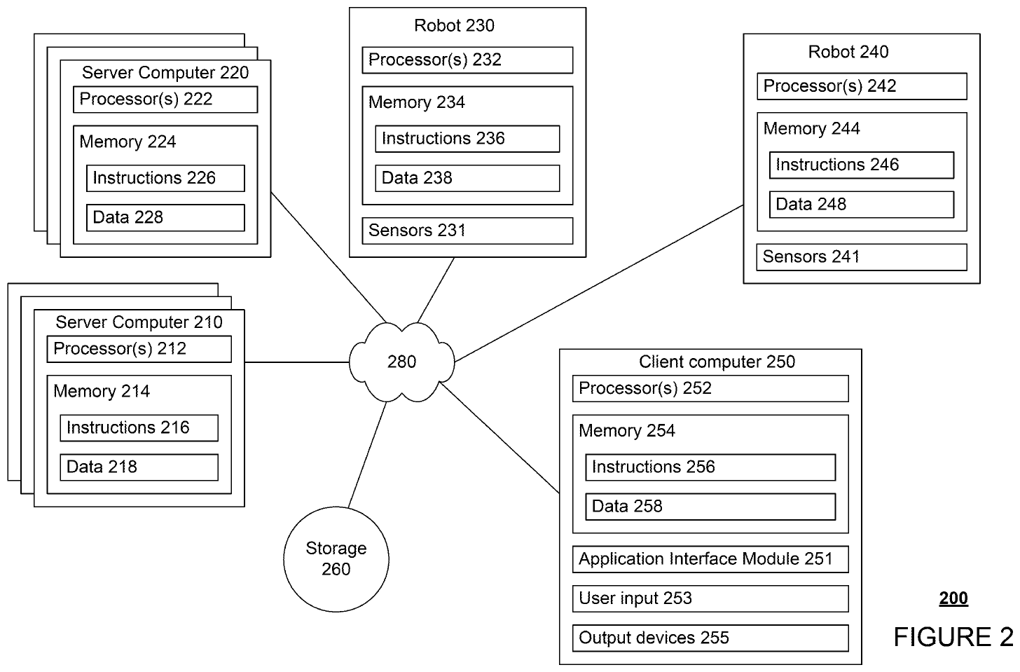

In this regard, the robotic control system 100 may be implemented in a distributed system that includes cloud resources. FIG. 2 is a functional diagram showing an example distributed system 200 for implementing the robotic control system 100. As shown, the system 200 may include a number of computing devices, such as server computers 210, 220 coupled to a network 280. For instance, the server computers 210, 220 may be part of a cloud computing system. The system 200 may also include one or more robots, such as robots 230 and 240 capable of communication with the server computers 210, 220 over the network 280. Further as shown, the system 200 may include one or more client computing devices, such as client computer 250 capable of communication with the server computers 210, 220, and/or the robots 230, 240 over the network 280.

Controllers of a robotic control system, such as those shown in FIG. 1, may be distributed on the distributed system 200. For example, one or more high-level controllers, such as the high-level controller 110, and one or more mid-level controllers, such as the mid-level controller 120, may be implemented by one or more processors in a cloud computing system, such as by processors 212, 222 of server computers 210, 220. For another example, one or more low-level controllers, such as the low-level controllers 130 and/or 140, may be implemented by one or more processors located on robots, such as processors 232, 242 of robots 230, 240. Further, databases for maintaining persistent and consistent records of intents and/or statuses of the controllers, such as the databases 160, may be implemented on the cloud computing system, such as in data 218, 228 of server computers 210, 220, and on the robots, such as in data 238, 248 of robots 230, 240.

As shown, the server computer 210 may contain one or more processor 212, memory 214, and other components typically present in general purpose computers. The memory 214 can store information accessible by the processors 212, including instructions 216 that can be executed by the processors 212. Memory can also include data 218 that can be retrieved, manipulated or stored by the processors 212. The memory 214 may be a type of non-transitory computer readable medium capable of storing information accessible by the processors 212, such as a hard-drive, solid state drive, tape drive, optical storage, memory card, ROM, RAM, DVD, CD-ROM, write-capable, and read-only memories. The processors 212 can be a well-known processor or other lesser-known types of processors. Alternatively, the processor 212 can be a dedicated controller such as an ASIC.

The instructions 216 can be a set of instructions executed directly, such as computing device code, or indirectly, such as scripts, by the processors 212. In this regard, the terms “instructions,” “steps” and “programs” can be used interchangeably herein. The instructions 216 can be stored in object code format for direct processing by the processors 212, or other types of computer language including scripts or collections of independent source code modules that are interpreted on demand or compiled in advance. Functions, methods, and routines of the instructions are explained in more detail in the foregoing examples and the example methods below. The instructions 216 may include any of the example features described herein.

The data 218 can be retrieved, stored or modified by the processors 212 in accordance with the instructions 216. For instance, although the system and method is not limited by a particular data structure, the data 218 can be stored in computer registers, in a relational database as a table having a plurality of different fields and records, or XML documents. The data 218 can also be formatted in a computer-readable format such as, but not limited to, binary values, ASCII or Unicode. Moreover, the data 218 can include information sufficient to identify relevant information, such as numbers, descriptive text, proprietary codes, pointers, references to data stored in other memories, including other network locations, or information that is used by a function to calculate relevant data.

Although FIG. 2 functionally illustrates the processors 212 and memory 214 as being within the same block, the processors 212 and memory 214 may actually include multiple processors and memories that may or may not be stored within the same physical housing. For example, some of the instructions 216 and data 218 can be stored on a removable CD-ROM and others within a read-only computer chip. Some or all of the instructions and data can be stored in a location physically remote from, yet still accessible by, the processors 212. Similarly, the processors 212 can include a collection of processors that may or may not operate in parallel. The server computers 210, 220 may each include one or more internal clocks providing timing information, which can be used for time measurement for operations and programs run by the server computers 210, 220.

The server computers 210, 220 may be positioned a considerable distance from one another. For example, the server computers may be positioned in various countries around the world. The server computers 210, 220 may implement any of a number of architectures and technologies, including, but not limited to, direct attached storage (DAS), network attached storage (NAS), storage area networks (SANs), fibre channel (FC), fibre channel over Ethernet (FCoE), mixed architecture networks, or the like. In some instances, the server computers 210, 220 may be virtualized environments.

Server computers 210, 220, robots 230, 240, and client computer 250 may each be at one node of network 280 and capable of directly and indirectly communicating with other nodes of the network 280. For example, the server computers 210, 220 can include a web server that may be capable of communicating with robot 230 via network 280 such that it uses the network 280 to transmit information to an application running on the robot 230. Server computers 210, 220 may also be computers in a load balanced server farm, which may exchange information with different nodes of the network 280 for the purpose of receiving, processing and transmitting data to robots 230, 240, and/or client computer 250. Although only a few server computers 210, 220 are depicted in FIG. 2, it should be appreciated that a typical system can include a large number of connected server computers with each being at a different node of the network 280.

Each robot 230, 240 may be configured similarly to server computers 210, 220, with processors 232, 242, memories 234, 244, instructions 236, 246, and data 238, 248. Further as shown in FIG. 2, robots 230, 240 may include one or more sensors, such as sensors 231, 241 respectively. For instance, sensors may include a visual sensor, an audio sensor, a touch sensor, etc. Sensors may also include motion sensors, such as an Inertial Measurement unit (“IMU”). According to some examples, the IMU may include an accelerometer, such as a 3-axis accelerometer, and a gyroscope, such as a 3-axis gyroscope. The sensors may further include a barometer, a vibration sensor, a heat sensor, a radio frequency (RF) sensor, a magnetometer, and a barometric pressure sensor. Additional or different sensors may also be employed.

The robots 230, 240 may further include any of a number of additional components. For example, the robots 230, 240 may further include position determination modules, such as a GPS chipset or other positioning system components. For another example, the robots 230, 240 may further include user inputs, such as keyboards, microphones, touchscreens, etc., and/or output devices, such as displays, speakers, etc. For still another example, the robots 230, 240 may each include one or more internal clocks providing timing information, which can be used for time measurement for operations and programs run by the robots. Although only a few robots 230, 240 are depicted in FIG. 2, it should be appreciated that the system can include a large number of robots with each being at a different node of the network 280.

The client computer 250 may also be configured similarly to server computers 210, 220, with processors 252, memories 254, instructions 256, and data 258. The client computer 250 may have all of the components normally used in connection with a personal computing device such as a central processing unit (CPU), memory (e.g., RAM and internal hard drives) storing data and instructions, input and/or output devices, sensors, clock, etc. Client computer 250 may comprise a full-sized personal computing device, they may alternatively comprise mobile computing devices capable of wirelessly exchanging data with a server over a network such as the Internet. For instance, client computer 250 may be a desktop or a laptop computer, or a mobile phone or a device such as a wireless-enabled PDA, a tablet PC, or a netbook that is capable of obtaining information via the Internet, or a wearable computing device, etc.

The client computer 250 may include an application interface module 251. The application interface module 251 may be used to access a service made available by one or more server computers, such as server computers 210, 220. The application interface module 251 may include sub-routines, data structures, object classes and other type of software components used to allow servers and clients to communicate with each other. In one aspect, the application interface module 251 may be a software module operable in conjunction with several types of operating systems known in the arts. Memory 254 may store data 258 accessed by the application interface module 251. The data 258 can also be stored on a removable medium such as a disk, tape, SD Card or CD-ROM, which can be connected to client computer 250.

Further as shown in FIG. 2, client computer 250 may include one or more user inputs 253, such as keyboard, mouse, mechanical actuators, soft actuators, touchscreens, microphones, sensors, and/or other components. The client computer 250 may include one or more outputs devices 255, such as a user display, a touchscreen, one or more speakers, transducers or other audio outputs, a haptic interface or other tactile feedback that provides non-visual and non-audible information to the user. Although only one client computer 250 is depicted in FIG. 2, it should be appreciated that the system can include a large number of client computers with each being at a different node of the network 280.

As with memory 214, storage system 260 can be of any type of computerized storage capable of storing information accessible by one or more of the server computers 210, 220, robots 230, 240, and client computer 250, such as a hard-drive, memory card, ROM, RAM, DVD, CD-ROM, write-capable, and read-only memories. In addition, storage system 260 may include a distributed storage system where data is stored on a plurality of different storage devices which may be physically located at the same or different geographic locations. Storage system 260 may be connected to computing devices via the network 280 as shown in FIG. 2 and/or may be directly connected to any of the server computers 210, 220, robots 230, 240, and client computer 250.

Server computers 210, 220, robots 230, 240, and client computer 250 can be capable of direct and indirect communication such as over network 280. For example, using an Internet socket, the client computer 250 can connect to a service operating on remote server computers 210, 220 through an Internet protocol suite. Server computers 210, 220 can set up listening sockets that may accept an initiating connection for sending and receiving information. The network 280, and intervening nodes, may include various configurations and protocols including the Internet, World Wide Web, intranets, virtual private networks, wide area networks, local networks, private networks using communication protocols proprietary to one or more companies, Ethernet, WiFi (for instance, 802.81, 802.81b, g, n, or other such standards), and HTTP, and various combinations of the foregoing. Such communication may be facilitated by a device capable of transmitting data to and from other computers, such as modems (for instance, dial-up, cable or fiber optic) and wireless interfaces.

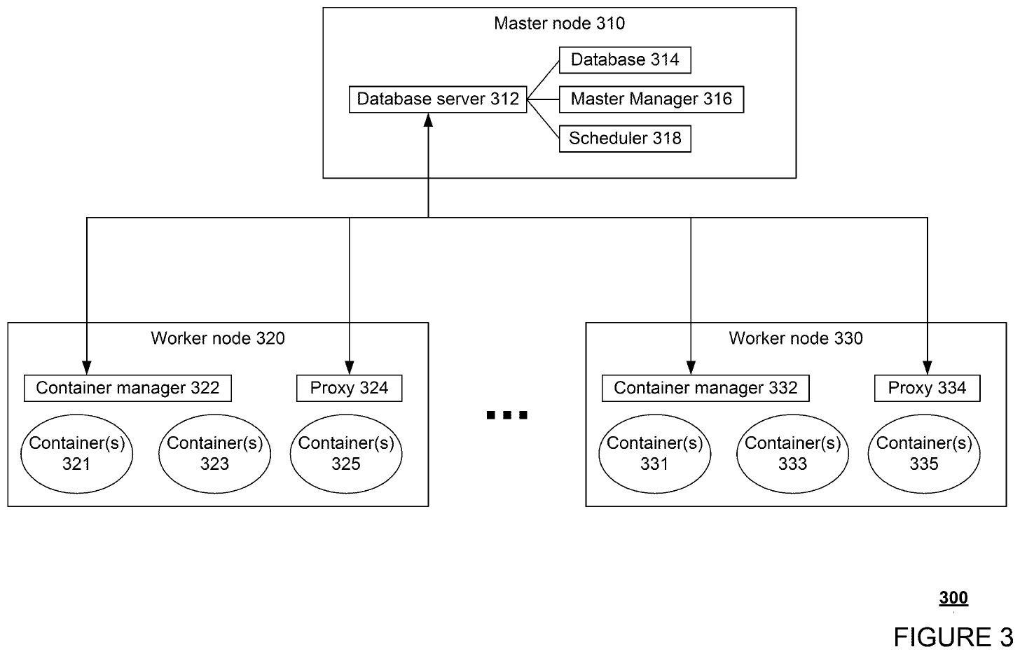

In order to efficiently use the processing and/or storage resources in a distributed system such as the distributed system 200, in some instances the robotic control system 100 may be implemented using a container orchestration architecture. FIG. 3 is a functional diagram illustrating an example container orchestration architecture. For instance, a user, such as a developer, may design controller applications. For example, the user may provide configuration data for the controller applications. The container orchestration architecture may be configured to package various services of the controller application into containers. The containers may then be deployed on a cloud computing system, for example for execution by processors 212, 222 (FIG. 2) of server computers 210, 220, and/or on robots, for example for execution by processors 232, 242 of robots 230, 240. The container orchestration architecture may be configured to allocate resources for the containers, load balance services provided by the containers, and scale the containers (such as by replication and deletion).

As shown in FIG. 3, the container orchestration architecture may be configured as a cluster 300. For instance as shown, the cluster 300 may include a master node 310 and a plurality of worker nodes, such as worker node 320 and worker node 330. Each node of the cluster 300 may be running on a physical machine or a virtual machine. The master node 310 may control the worker nodes 320, 330. The worker nodes 320, 330 may include containers of computer code and program runtimes that form part of the user designed application. In some instances, the containers may be further organized into one or more container groups. For example as shown, the worker node 320 may include containers and/or container groups 321, 323, 325.

The master node 310 may be configured to manage resources of the worker nodes 320, 330. For instance as shown, the master node 310 may include a database server 312. The database server 312 may be in communication with the database 314, the master manager 316, and the scheduler 318.

The database server 312 may configure and/or update objects stored in the database 314. For example, the objects may include information (such as key values) on containers, container groups, replication components, etc. For instance, the database server 312 may be configured to be notified of changes in states of various items in the cluster 300, and update objects stored in the database 314 based on the changes. As such, the database 314 may be configured to store configuration data for the cluster 300, which may be an indication of the overall state of the cluster 300. For instance, the database 314 may include a number of objects, the objects may include one or more states, such as intents and statuses. For example, the user may provide the configuration data, such as desired state(s) for the cluster 300.

The database server 312 may be configured to provide intents and statuses of the cluster 300 to a master manager 316. The master manager 316 may be configured to run control loops to drive the cluster 300 towards the desired state(s). For example, a control loop may be a non-terminating loop that regulates a state of a robotic system. In this regard, the master manager 316 may watch state(s) shared by nodes of the cluster 300 through the database server 312 and make changes attempting to move the current state towards the desired state(s). The master manager 316 may be configured to perform any of a number of functions, including managing nodes (such as initializing nodes, obtain information on nodes, checking on unresponsive nodes, etc.), managing replications of containers and container groups, etc.

The database server 312 may be configured to provide the intents and statuses of the cluster 300 to the scheduler 318. For instance, the scheduler 318 may be configured to track resource use on each worker node to ensure that workload is not scheduled in excess of available resources. For this purpose, the scheduler 318 may be provided with the resource requirements, resource availability, and other user-provided constraints and policy directives such as quality-of-service, affinity/anti-affinity requirements, data locality, and so on. As such, the role of the scheduler 318 is to match resource supply to workload demand.

The database server 312 may be configured to communicate with the worker nodes 320, 330. For instance, the database server 312 may be configured to ensure that the configuration data in the database 314 matches that of containers in the worker nodes 320, 330, such as containers 321, 323, 325, 331, 333, 335. For example as shown, the database server 312 may be configured to communicate with container managers of the worker nodes, such as container managers 322, 332. The container managers 322, 332 may be configured to start, stop, and/or maintain the containers based on the instructions from the master node 310. For another example, the database server 312 may also be configured to communicate with proxies of the worker nodes, such as proxies 324, 334. The proxies 324, 334 may be configured to manage routing and streaming (such as TCP, UDP, SCTP), such as via a network or other communication channels. For example, the proxies 324, 334 may manage streaming of data between worker nodes 320, 330.

The cluster 300 may conform to one or more declarative Application Programming Interfaces (APIs). For instance, the declarative APIs may define message format, objects, and/or other rules that nodes of the cluster 300 must conform to. In this regard, the declarative APIs may be predefined in a central repository. For example, the central repository may be stored in the master node 310, such as in database 314, in worker nodes 320, 330, or a memory external to the cluster 300 but accessible to the cluster 300.

Although only one master node 310 is shown, the cluster 300 may additionally include a plurality of master nodes. For instance, the master node 310 may be replicated to generate a plurality of master nodes. The plurality of master nodes may improve performance of the cluster by continuing to manage the cluster even when one or more master nodes may fail. In some instances, the plurality of master nodes may be distributed onto different physical and/or virtual machines.

The robotic control system 100 may be implemented using one or more clusters such as the cluster 300 shown. For example, the high-level controller 110 may be designed as an application having various desired states, and thus can be deployed on a cluster such as cluster 300. As such, the database server 312 may configure objects in the database 314 with these desired states; the master manager 316 may drive control loops to move the current states of the cluster 300 towards the desired states; and the scheduler 318 may be configured to allocate resources for the containers 321, 323, 325, 331, 333, 335 running the worker nodes 320, 330. Further, the mid-level controller 120 may be running on worker nodes, such as worker nodes 320, 330, which may complete tasks to bring the current states of the high-level controller 110 closer to the desired states. As such, intents and statuses of the high-level controller 110 as well as the intents and statuses of the mid-level controller 120 may be stored and updated in the database 314 by the database server 312. For another example, the mid-level controller 120 may interact with a master node in a second cluster (not shown), such as sending intents to the database server of a master node in the second cluster. The database server of the second cluster may store and/or update the intents in the database of the second cluster. The master node in the second cluster may also manage various worker nodes, which for example may implement low-level controllers 130, 140. The worker nodes of the second cluster may send statuses of the low-level controllers 130, 140 to the database server of the second cluster, which may be stored in the database of the second cluster. Additionally, in some examples the database of the second cluster may further store states of the first cluster, and/or the database 314 of the first cluster 300 may further store states of the second cluster, etc.

### Example Methods

Further to example systems described above, example methods are now described. Such methods may be performed using the systems described above, modifications thereof, or any of a variety of systems having different configurations. It should be understood that the operations involved in the following methods need not be performed in the precise order described. Rather, various operations may be handled in a different order or simultaneously, and operations may be added or omitted.

For instance, the system 200 shown in FIG. 2 may receive user input including configuration data for one or more controllers. For example, in order to control one or more robots, a user, such as a developer, may design one or more controllers. For example, the controllers may be applications that can run on one or more processors, such as processors 212, 222 on a cloud system, or processors 232, 242 on robots. For instance, the user may build the controllers on a client computing device, such as client computer 250. For example, the user may enter code using user inputs 253 and view the code using output devices 255.

In some instances, the system 200 may receive user input specifying which controller is to be implemented on a cloud computing system and which controller is to be implemented locally on robots. For instance, the user may specify a cluster on the cloud computing system (or robot) schedules events for each controller, and that cluster may determine how the controller is to be run by the worker nodes. As such, application interface module 251 may transmit the relevant code of the user designed applications to a cloud computing system and one or more robots, for implementation. For example, some of the code may be transmitted to processors 212, 222, which may deploy one or more clusters, such as cluster 300, on server computers 210, 220 to implement one or more controllers on the cloud, while some of the code may be transmitted to processors 232, 242, which may deploy one or more clusters, such as cluster 300, to implement one or more controllers on the robot.

The user input received by system 200 may be written as declarative programs. Declarative programming is a style of building the structure and elements of computer programs which describes what the program must accomplish, rather than how to accomplish it as a sequence of explicit steps. For instance, the user may build the controllers using declarative programming by specifying desired state(s) for the controllers, and allow a containerized architecture, such as the cluster 300 of FIG. 3, to implement control flow to reach the desired state(s), rather than explicitly describing the steps that the controllers must execute. For example, the database server 312 may store the desired state(s) in database 314, and provide the desired state(s) to various components to drive the cluster 300 towards the desired state(s). As some examples, the desired states may include a target position, a target movement, a target charge level, light on/off, a target shelf to pick up a box, etc.

Thus, a controller may have an intent specifying the desired state(s), a status specifying the current state(s), and code that picks a series of state transitions in order to match the status to the intent. By way of example only, the code that picks the series of state transitions may be implemented as state machines.

The one or more controllers may conform to one or more declarative Application Programming Interfaces (APIs). For instance, the declarative APIs may define message format, objects, and/or other rules. For instance, a central repository may include definitions for declarative APIs related to any of a number of tasks for the robot and/or its components. For example, the declarative APIs may relate to common tasks such as move, charge, get trolley, etc. In addition to the declarative APIs in the central repository, the system 200 may also receive user input defining custom declarative APIs related to any of a number of functionalities. For instance, the user may define custom declarative APIs using the client computer 250. For example as mentioned above in example systems, the central repository may be stored in the cluster 300 or in an external memory accessible by the cluster 300.

In some instances, the declarative APIs may be configured to be independent of programming language. As such, even in instances where various controllers of a robot are written in different programming languages, the controllers may be able to communicate with one another because the controllers conform to the same declarative APIs.

The user input configuring controller applications received by system 200 may include definitions of objects that can be used by the controller applications in order to reach the desired states. For instance, the objects may be actions that can be carried out by the robot, such as charge, move, get trolley, etc. Such objects may be defined by the declarative APIs, or may be defined by the user. In either case, the user may define schema for the objects, such as which one or more fields of an object make up that object's intent, and/or which one or more fields of the object make up that object's status.

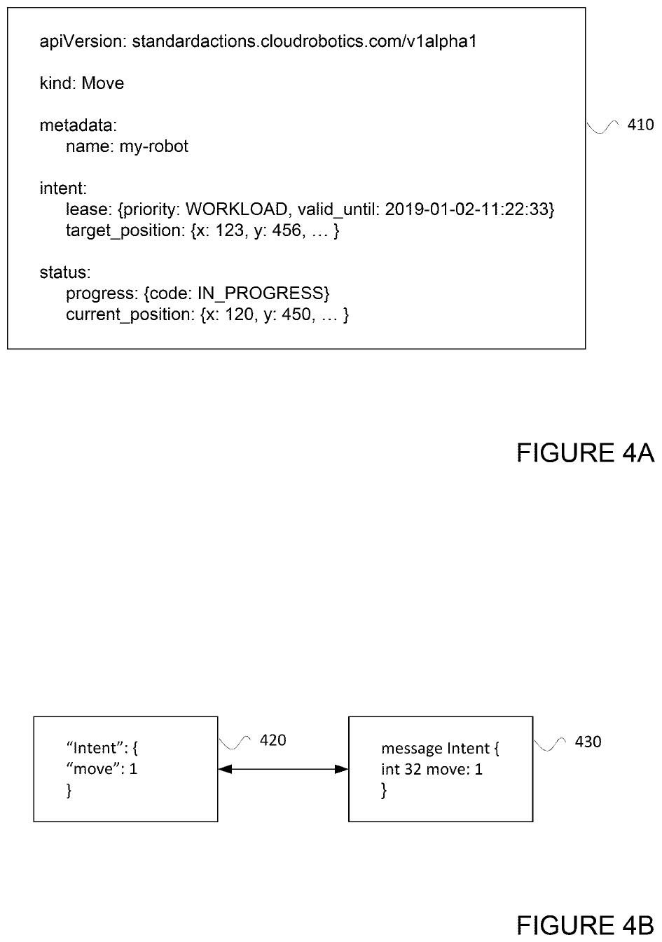

FIG. 4A shows an example schema 410 for an example resource that one or more controllers may use, in particular the example shows an object. For instance, a user may input the schema 410 for an object. For another instance, a controller may request or send a message including the schema 410 in order to manipulate an object defined by a central repository. As shown, the schema 410 includes a “kind” for the object “Move.” The schema 410 may include metadata for the object, such as name of the robot that may use the object “my-robot.” The schema 410 may include “intent,” which includes the field “target_position” as the object's desired state. The schema 410 may also include the “status,” which includes the fields “progress” and “current_position” as the object's current states. Further as shown, the schema 410 may include other additional fields, which are discussed further below.

The system 200 may store and update intents and statuses in databases, such as databases 160, which as described above may be implemented on the cloud such as server computers 210, 220 and/or on the robot such as robots 230, 240. For instance, in a cluster such as cluster 300, these updates may be performed by database server 312. In this regard, where databases 160 include databases implemented both on cloud and robots, a database server of a cluster on the cloud may update a database on the cloud, while a database server of a cluster on the robot may update a database on the robot.

In instances where the databases may be written in a different programming language as the controllers, the system 200 may translate between the different languages. For instance, FIG. 4B shows an example of an object 420 stored in a database. As shown, the object 420 is written in a non-type or typesafe programming language, which does not depend on data types such as integer v. string. For example, such typesafe programming language may include YAML, JSON, etc. Further as shown, the message 430 from a controller is written in a typed programming language, which does depend on data types. For example, such typed programming language may include C, C++, Java, GO, etc. As such, in some instances one or more adaptors may be provided in the system 200 for translating between languages with untyped data and languages with typed data. For example, the translation may be performed by a code generator. For instance, the code generator may generate source code based on descriptions of data structure. In this regard, where clusters are deployed both on the cloud and robot, adaptor(s) on the cloud may perform translations on the cloud, while adaptor(s) on the robot may perform translations on the robot.

Still further, in instances where controllers may have different communication interfaces for interacting with databases and for interacting with other controllers and/or components of the robot, the system 200 may convert between the different communication interfaces. For instance, a controller may have a poll-based communication interface for interacting with the databases (where the controller lists and watches all resources and checks for differences), and a request-based communication interface for controlling functions of the robot (where the controller gets notified of changes). Request-based communication interfaces may include, for example, Remote Procedural Calls (RPC), some implementations of Publish/Subscribe (PUB/SUB), etc. Poll-based communication interface may include, for example, Representational State Transfer (REST) APIs, some implementations of PUB/SUB, etc. In order to facilitate communication despite these variances in the distributed system, one or more adaptors may be provided in the system 200. In this regard, where clusters are deployed both on the cloud and robot, adaptor(s) on the cloud may perform conversions on the cloud, while adaptor(s) on the robot may perform conversions on the robot.

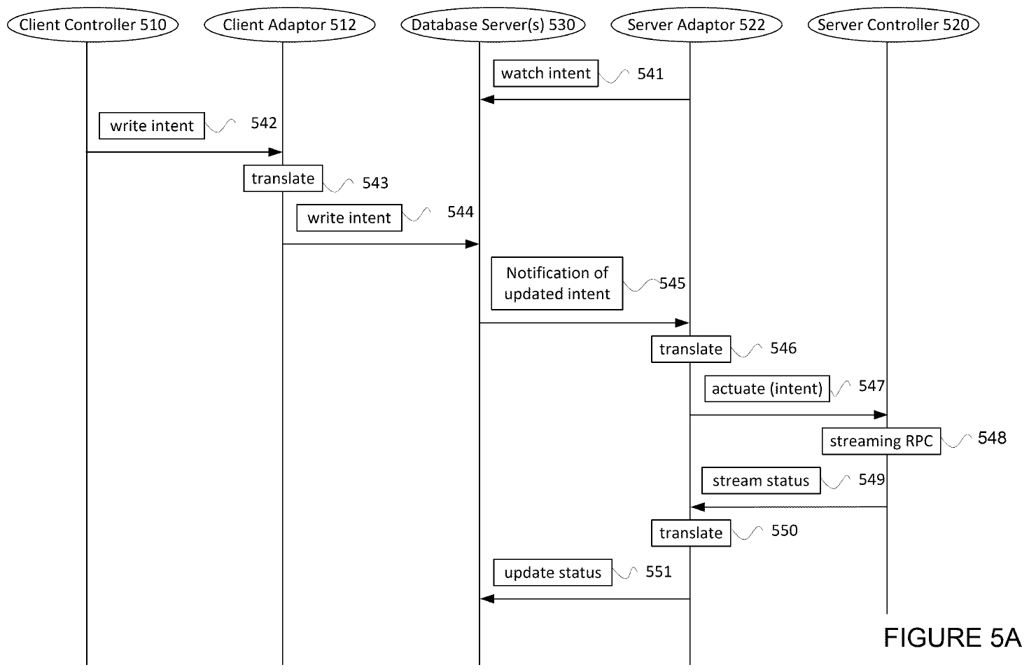

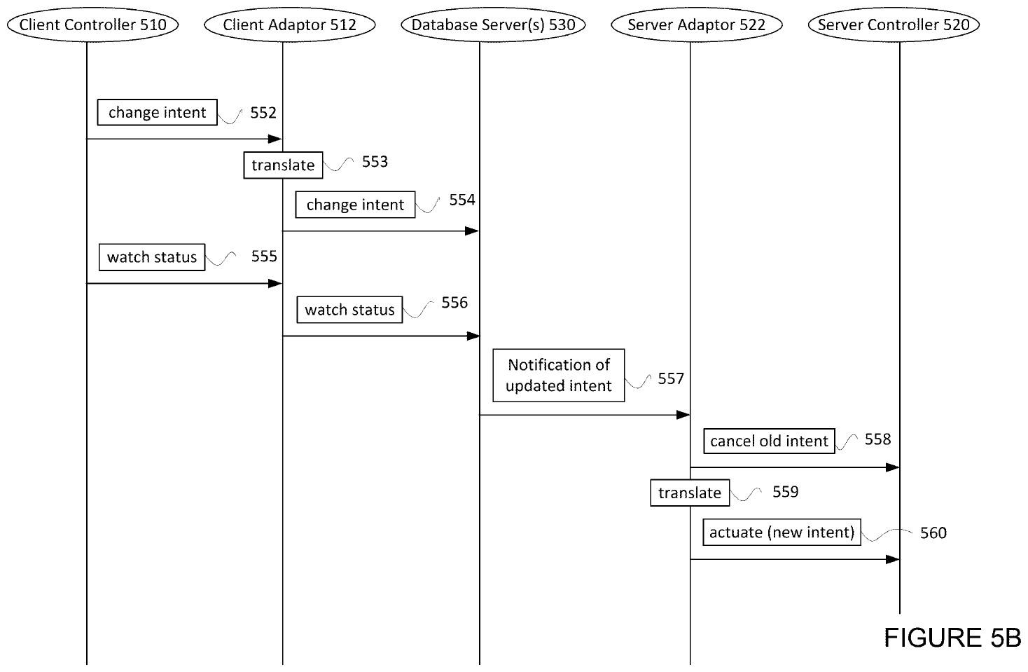

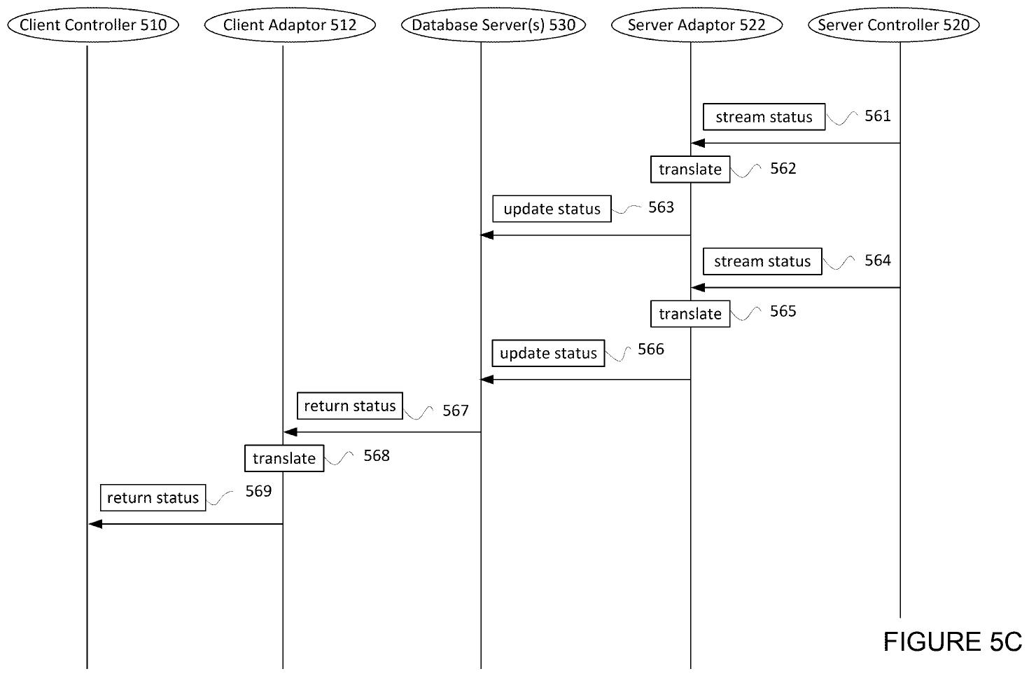

FIGS. 5A-5C show example timing diagrams, which help illustrate example implementations for controlling a robot using a distributed system. The blocks in FIGS. 5A-5C contain brief descriptions of example operations discussed further below, and the arrows represent the flow of data, code, message, or information between various components. The example operations shown in FIGS. 5A-5C may be performed by one or more processors, such as one or more of the processors 212, 222, 232, 242, 252. The operations shown in FIGS. 5A-5C may be implemented using containerized architecture, such as on one or more clusters as shown in FIG. 3.

FIGS. 5A-5C show interactions between a client controller 510 and a server controller 520. In this regard, the client controller 510 may have a higher hierarchy than the server controller 520. As such, the server controller 520 performs functions that “serves” the client controller 510. For example, the client controller 510 may be the high-level controller 110 and the server controller 520 may be the mid-level controller 120 shown in FIG. 1. For another example, the client controller 510 may be the mid-level controller 120 and the server controller 520 may be the low-level controller 130 shown in FIG. 1.

The client controller 510 and server controller 520 may be both running on a cloud computing system, such as on processors 212, 222, or both running on a robot, such as on processors 232, 242. Alternatively, the client controller 510 may be running on the cloud computing system while the server controller 520 may be running on the robot. As described below, where either or both client and server controllers are running the cloud computing system, states of both controllers may be stored and updated on a cloud database. In instances where both client and server controllers are running on the robot, states of the controllers may be stored and updated on a cloud database on a best effort basis, such as at regular intervals.

The client controller 510 and server controller 520 may communicate via a communication layer, which may include one or more database server(s) 530 and one or more adaptors 512, 522. As described above, a controller on a cloud may interact with adaptors on the cloud, while a controller on a robot may interact with adaptors on the robot. As such, the client adaptor 512 and server adaptor 522 shown may be either on the cloud or the robot, depending on whether client controller 510 and/or server controller 520 are on the cloud or the robot.

Likewise, the one or more database server(s) 530 may be implemented on both the cloud and the robot. For example, if both the client controller 510 and the server controller 520 are running on the cloud, the two controllers 510, 520 may both use a database server on the cloud to update the cloud database. For another example, if both the client controller 510 and the server controller 520 are running on the robot, the two controllers 510, 520 may both use a database server on the robot to update the robot database. For still another example, if the client controller 510 is running on the cloud but the server controller 520 is running on the robot, the client controller 510 may use a database server on the cloud to update the cloud database, while the server controller 520 may use a database server on the robot to update the robot database. In such instances, the databases may be synchronized by a replication component.

Referring to FIG. 5A, the server adaptor 522 may “watch” 541 for changes occurring at the database server(s) 530. For instance, the server adaptor 522 may build a local cache of contents of the database server(s) 530, and watch for changes in intent in all objects where actuation (or further control) by the server controller 520 may be needed. For example, such objects may be created by client controller 510, with intents that the server controller 520 may meet by actuating various components. In this regard, the server adaptor 522 may use a poll-based communication interface when interacting with the database server(s) 530. For example, in instances where the server controller 520 is running on the robot, the server controller 520 may watch the database server running on the robot.

At some point as shown, the client controller 510 may “write” 542 an “intent” to the client adaptor 512. For instance, the client controller 510 may create an object and define the object's schema, such as a “move” object shown in FIG. 4A. For instance, the client controller 510 may do so by requesting to create or manipulate a “move” object, where various properties of the “move” object may be defined in the central repository. Further as shown in FIG. 4A, the intent may include desired states, such as to move to a target position. The client adaptor 512 may translate 543 the intent from a language of the client controller 510 to a language of the database. For example as described above with respect to FIG. 4B, the client adaptor 512 may translate a typed programming language of the client controller 510 to an untyped programming language of the database. The client adaptor 512 may then write 544 the translated intent to the database server(s) 530. For example, in instances where the client controller 510 is running on the cloud, the client adaptor 512 may write the translated intent to the database server running on the cloud.

The database server(s) 530 may update one or more databases with the received intent. For example, where both controllers 510, 520 are running on the cloud, the database server on the cloud may update the cloud database with the received intent. For another example, where both controllers 510, 520 are running on the robot, the database server on the robot may update the robot database with the received intent. Still further, in instances where the client controller 510 is running on the cloud and the server controller 520 is running on the robot, the database server on the cloud may update the cloud database while the database server on the robot may update the robot database.

While watching for updates, the server adaptor 522 may receive a notification 545 of the updated intent. The server adaptor 522 may translate 546 the updated intent from a programming language of the database to a programming language of the server controller 520. For example as described above with respect to FIG. 4B, the server adaptor 522 may translate an untyped programming language of the database to a typed programming language of the server controller 520. The server adaptor 522 may then actuate 547 the intent on the server controller 520. In this regard, as described above, the server adaptor 522 may have received the notification 545 via a poll based communication interface with the database, and may need to convert to a request based communication interface for interacting with the server controller 520 (and/or components of robot). For example, the server adaptor 522 may send the intent via a remote procedural call (RPC) method to the server controller 520. Based on the intent, the server controller 520 may actuate one or more mechanical and/or electrical components, or may send commands to another controller.

As shown, the server controller 520 may be running a streaming RPC 548. For example, the server controller 520 may be configured to run a long-running server-streaming RPC for sending information, such as status of the server controller 520. For instance, the server controller 520 may stream 549 a status to the server adaptor 522. For example as shown in FIG. 4A, the status may include current state, such as current position. For instance, the status may indicate a status of the task to be completed based on the intent written by the client controller 510. For example, the status may indicate that wheels had been turned. The server adaptor 522 may translate 550 the status from the programming language of the server controller 520 to the programming language of the database. Further in this regard, the server adaptor 522 may need to convert from using a request based communication interface to receive the status from the server controller 520 to a poll based communication interface to update the status of the database server 530. The server adaptor 522 may then update 551 the translated status of the database server(s) 530. For example, in instances where the server controller 520 is running on the robot, the server adaptor 522 may write the translated status to the database server running on the robot.

Once the database server(s) 530 receives the translated status, the database server(s) 530 may update one or more databases with the received status. For example, where both controllers 510, 520 are running on the cloud, the database server on the cloud may update the cloud database with the received status. For another example, where both controllers 510, 520 are running on the robot, the database server on the robot may update the robot database with the received status. Still further, in instances where the client controller 510 is running on the cloud and the server controller 520 is running on the robot, the database server on the cloud may update the cloud database while the database server on the robot may update the robot database.

In instances where more than one database needs to be updated, a replication component may synchronize the databases. Any of a number of replication patterns may be used. For instance, a replication component may synchronize the stored intent from the cloud database to the robot database. For another instance, a replication component may synchronize the stored status from the robot database to the cloud database. For example, such replication components may be part of the worker nodes in a cluster.

Referring to FIG. 5B, the client controller 510 may change 552 the intent for the server controller 520. For example, the client controller 510 may change the intent of the “move” object previously created to a new target position, or create a new object with the new intent. For instance, the client controller 510 may write a new intent based on the updated status. For example, the client controller 510 may determine that no box exists on shelf A, thus may change the intent to “pick up a box from shelf B.” For another instance, the client controller 510 may change the intent based on other factors, such as based on a new intent from a controller with a higher hierarchy than client controller 510, based on a user input, or based on detecting an emergency. The client adaptor 512 may translate 553 the received intent, and change 554 the intent of the database server(s) 530. For example, in instances where the client controller 510 is running on the cloud, the client adaptor 512 may write the changed intent to the database server running on the cloud.

Upon changing the intent, the client controller 510 may start to watch 555 the client adaptor 512 for new statuses. In particular, the client controller 510 may watch for changes in status for the object whose intent the client controller 510 just changed, or the new object client controller 510 just created. In this regard, the client controller 510 may similarly “watch” for statuses after writing the intent at 542. For instance, the client controller 510 may use a poll-based communication interface to interact with the client adaptor 512, and the client adaptor 512 may then start to watch 556 the database server(s) 530 for new statuses. For instance, the client adaptor 512 may build a local cache of contents of the database server(s) 530, and watch for changes. For example, in instances where the client controller 510 is running on the cloud, the client adaptor 512 may watch the database server running on the cloud.

The server adaptor 522 may receive a notification 557 of the updated intent. As such, the server adaptor 522 may cancel 558 the previous actuate (intent). For example, the server adaptor 522 may cancel a previous RPC including the previous intent. As described above, the server adaptor 522 may translate 559 the updated intent, and/or convert from a poll based communication interface to a request based communication interface. The server adaptor 522 may then actuate 560 the new intent on the server controller 520. Based on the new intent, the server controller 520 may actuate one or more mechanical and/or electrical components, or may send commands to another controller.

Referring to FIG. 5C, the server controller 520 may stream 561 a new status to the server adaptor 522 for the new intent. For instance, the status may indicate a status of the task to be completed based on the new intent. For example, the status may indicate that wheels had been turned. The server adaptor 522 may translate 562 the status, and/or convert from a request based communication interface to a poll based communication interface. The server adaptor 522 may then update 563 the status for the database server(s) 530. Once the database server(s) 530 receives the translated status, the database server(s) may update one or more databases with the received status as described above. Further as shown, the server controller 520 may continue to stream 564 a new status to the server adaptor 522, which may be translated 565 by the server adaptor 522 and updated 566 on the database server(s) 530.

This process may continue until a status indicating an end of the task is received by the database server 530. For example, if the server controller 520 determines that the status indicates that the current position matches the target position, the server controller 520 may output a final status, and end the streaming RPC that output its statuses. Database server(s) 530 may return 567 the status to the client adaptor 512. The client adaptor 512 may translate 568 the returned status, and then return 569 the translated status to the client controller 510. The client controller 510 may recognize that the received status indicates that the task is completed, and stops watching for new statuses.

In some instances, one or more controllers implemented by the system 200 may be configured to discover previously unknown capabilities of the robot, and control the robot based on the discovery. For example, an intermediate controller may be configured to receive from a high-level controller, intents for a low-level controller that it does not know or understand, but may nonetheless be configured to manage cloud resources for the robot. For example, the intermediate controller may receive a mission including intents “move to point a, blink lights, pick up box,” without understanding “blink lights,” but still able to pass down the intents in the proper sequence to one or more lower-level controllers.

For instance, such intermediate controllers may be implemented using containerized orchestration architecture such as cluster 300 of FIG. 3. For example, the intermediate controller may use the master manager 316 and scheduler 318 to template, deploy, and update arbitrary objects, where the objects may define the desired applications, workloads, virtual device images, replication, network resources, etc. Further, the intermediate controller may use the database server 312 to receive and update intents and statuses in database 314 without understanding all the details of the intents and statuses. In some examples, the status of objects that can be stored in database 314 may be defined by the declarative APIs to include a field with standardized codes. For example as shown in FIG. 4A, the status may include a progress field, which may be filled with standard codes such as “CREATED,” “IN PROGRESS,” “CANCELED,” “ERROR.” As such, regardless of whether the intermediate controller understands a task, it may update and understand at least the standardized codes.

In some instances, the system 200 may resolve conflicts when multiple controllers are competing for a same type of resource. For instance, conflict resolving mechanisms can be implemented using the containerized architecture of FIG. 3. Referring again to FIG. 4A, which shows an example object. In some instances, each action of a robot may be provided with one resource including one or more objects. Thus, multiple controllers may be competing for a same type of object. As such, a conflict resolution mechanism may be needed.

In some examples, conflict resolution may be performed by requiring a controller to obtain a lease before manipulating a resource or object. As such, objects stored for example in database 314 cannot be updated without a lease. For instance as shown in FIG. 4A, the lease may include a priority level and an expiration time. Examples of priority levels may include emergency, high, workload, low, etc. As such, the controller may only be allowed to write the intent for a lower-level controller when the controller has such a lease. For another instance, a controller with a lease having a certain priority may only be able to break other leases for a same type of resource held by other controllers which have lower priorities.

In other examples, an intermediate controller may be configured to perform conflict resolution. For example, the intermediate conflict resolving controller may be implemented on a cluster such as cluster 300, for example on a master or a worker node. For instance, a higher level controller in the control system may be configured to generate an intermediate conflict resolving resource containing a plurality of requests from multiple controllers requesting to manipulate a same type of resource. For example, the multiple controllers may each request to manipulate a same type of resource in a different way (e.g., one requests moving forward, another requests moving backwards). The intermediate conflict resolving resource may further include a priority level and/or a deadline for each request. Based on information in the intermediate conflict resolving resource, the intermediate controller may select the request with the highest priority among the plurality of requests, manipulate the resource as indicated by the selected request, and then pass the manipulated resource to a lower-level controller for actuation. For example, the lower-level controller's intent may be updated with the intent of the resource.

The two example conflict-resolving approaches have a number of advantages. For instance, actions of the robot may be defined in terms of each other. For example, one type of “move” may be defined in terms of another type of “move.” As another example, “fetch box” may be defined in terms of “move” and “pick up box.” For another instance, multiple non-conflicting actions may run in parallel. For example, no two controllers can manipulate a same type of object (e.g. “move”) at the same time, but the two controllers can both manipulate two different types of objects (e.g., “move” and “lift”).

As still another example, instead of conflict resolution, each robot may have only one resource of a type, which is updated with new actions. As such, controllers of the robot may check the resource to see whether it is responsible for executing the current action in the resource. For example, the resource may identify that a current action is to be executed by a particular controller. This way, leases are not needed, which may lock up resources. Further, it would not be necessary to create intermediate conflict-resolving controllers.

In another aspect, the system 200 may be configured to support multiple versions of APIs. Referring again to FIG. 4A, version information may be included in an object's schema. For example, the object of the kind Move shown in FIG. 4A conforms to an API version of “standardactions.cloudrobotics.com/v1alpha1.” For another example, there may be another object of the kind Move may conform to a different API version. The database 314 may be configured to store multiple versions of APIs and objects. As such, the master node 310 may ensure that objects provided to controllers conform to the same API versions. With support for multiple versions, APIs and/or controllers of the system may be updated even during operation, which avoids costly downtimes. Since currently, software for robotics are often purpose-built or only deployed a couple hundred times, the capabilities to support multiple versions may be particularly useful.

In still another aspect, for debugging purposes, in addition to updating and synchronizing the databases, the system 200 may generate a log of intents for the various controllers. Although in theory, a declarative system is hysteresis free, in some instances it may be helpful to determine how the robot has arrived at its current state, and whether any component of the robot in fact shows hysteresis (for example due to some error or environmental factor). As such, the distributed system 200 may run a process on the cloud, such as by processors 212, 222, as well as a process on the robot, such as by processors 232, 242, in order to monitor all resources in the system 200. The distributed system 200 may publish any observed changes of intent on a dashboard. For instance, the dashboard may be displayed on output devices 255 of client computer 250.

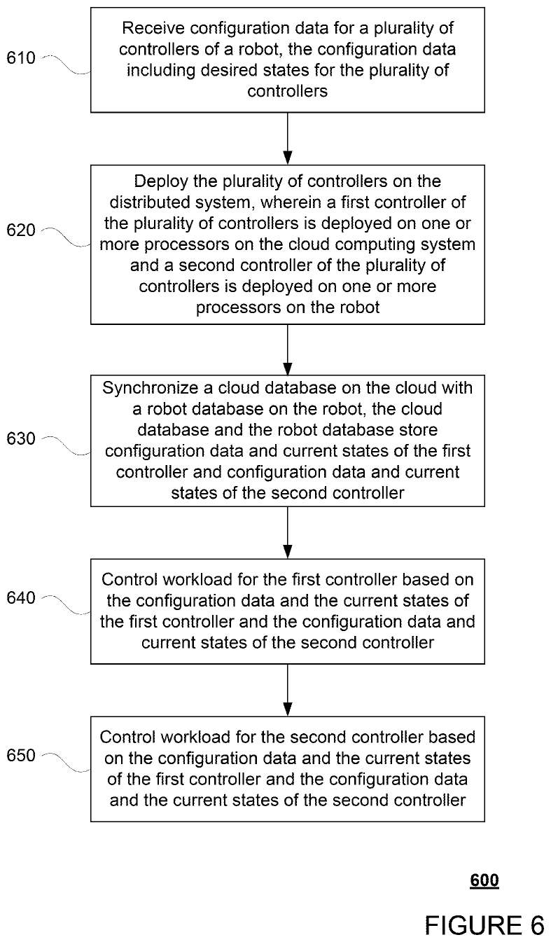

FIG. 6 is a flow diagram illustrating an example method 600 of implementing a robotic control system on a distributed system with synchronized databases. For instance, operations shown in the flow diagram may be performed by the example systems described herein, such as by one or more processors of the distributed system 200. For example, the system may be a robotic control system such as the robotic control system 100 shown in FIG. 1 and may be implemented using a containerized architecture such as shown in FIG. 3. While the operations are illustrated and described in a particular order, it should be understood that the order may be modified and that operations may be added or omitted. Referring to FIG. 6, in block 610, configuration data for a plurality of controllers of a robot is received, the configuration data including desired states for the plurality of controllers. In block 620, the plurality of controllers is deployed on the distributed system, wherein a first controller of the plurality of controllers is deployed on one or more processors on the cloud computing system and a second controller of the plurality of controllers is deployed on one or more processors on the robot. In block 630, a cloud database on the cloud is synchronized with a robot database on the robot, the cloud database and the robot database store configuration data and current states of the first controller and configuration data and current states of the second controller. In block 640, workload for the first controller is controlled based on the configuration data and the current states of the first controller and the configuration data and current states of the second controller. In block 650, workload for the second controller is controlled based on the configuration data and the current states of the first controller and the configuration data and the current states of the second controller.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method, comprising:
receiving, by one or more processors in a distributed system, configuration data for a plurality of controllers of a robot, wherein the distributed system includes at least one processor on a cloud computing system and at least one processor on the robot, and wherein the configuration data includes desired states for the plurality of controllers;
deploying, by the one or more processors, the plurality of controllers on the distributed system, wherein a first controller of the plurality of controllers is deployed on one or more processors on the cloud computing system and a second controller of the plurality of controllers is deployed on one or more processors on the robot;
synchronizing, by the one or more processors, a cloud database on the cloud computing system with a robot database on the robot, the cloud database and the robot database store configuration data and current states of the first controller and configuration data and current states of the second controller;
controlling, by the one or more processors, workload for the first controller based on the configuration data and the current states of the first controller and the configuration data and current states of the second controller; and
controlling, by the one or more processors, workload for the second controller based on the configuration data and the current states of the first controller and the configuration data and the current states of the second controller.

2. The method of claim 1, further comprising:
generating, by the one or more processors, a first master node on the cloud computing system, the first master node including the cloud database;
generating, by the one or more processors, a second master node on the robot, the second master node including the robot database.

3. The method of claim 2, further comprising:
generating, by the one or more processors, a plurality of worker nodes on the cloud computing system, wherein the first master node controls the worker nodes on the cloud computing system to perform the workload for the first controller;
generating, by the one or more processors, a plurality of worker nodes on the robot, wherein the second master node controls the worker nodes on the robot to perform the workload for the second controller.

4. The method of claim 3, further comprising:
receiving, by the one or more processors, statuses from the worker nodes on the cloud computing system;
updating, by the one or more processors, the cloud database with the received statuses;
comparing, by the one or more processors, the desired states of the first controller with the received statuses;
controlling, by the one or more processors, workload of the worker nodes on the cloud computing system based on the comparison.

5. The method of claim 3, further comprising:
receiving, by the one or more processors, statuses from the worker nodes on the robot;
updating, by the one or more processors, the robot database with the received statuses;
comparing, by the one or more processors, the desired states of the second controller with the received statuses;
controlling, by the one or more processors, workload of the worker nodes on the robot based on the comparison.

6. The method of claim 1, further comprising:
receiving, by the one or more processors, a first message from the first controller, the first message includes an intent for the second controller;
updating, by the one or more processors, the cloud database with the intent for the second controller;
synchronizing, by the one or more processors, the robot database with the updated cloud database, the synchronized robot database includes the intent for the second controller;
accessing, by the one or more processors, the intent for the second controller stored on the robot database;
controlling, by the one or more processors, workload for the second controller based on the intent for the second controller.

7. The method of claim 6, further comprising:
prior to updating the cloud database, translating, by the one or more processors, the first message from a programming language of the first controller into a programming language of the cloud database.

8. The method of claim 6, further comprising:
prior to controlling the workload for the second controller, converting, by the one or more processors, a poll based interface for accessing the robot database to a request based interface for interacting with the second controller.

9. The method of claim 1, further comprising:
receiving, by the one or more processors, a second message from the second controller, the second message reporting a status of the second controller;
updating, by the one or more processors, the robot database with the status for the second controller;
synchronizing, by the one or more processors, the cloud database with the updated robot database, the synchronized cloud database includes the status for the second controller;
accessing, by the one or more processors, the status for the second controller stored on the cloud database;
controlling, by the one or more processors, workload for the first controller based on the statues for the second controller.

10. The method of claim 6, wherein the first message conforms to rules defined by a declarative API, the declarative API being defined in a repository of the distributed system.

11. The method of claim 10, wherein the declarative API is independent of programming language.

12. The method of claim 10, wherein the declarative API includes a progress field with standardized codes, and wherein the first controller is configured to send messages for controlling unknown capabilities of the second controller based on the standardized codes.

13. The method of claim 1, wherein the configuration data further includes definitions for a plurality of resources each of the plurality of controllers can manipulate to perform workload.

14. The method of claim 13, further comprising:
obtaining, by the one or more processors, a first lease for the first controller for manipulating a resource of the plurality of resources, the first lease including a deadline, wherein other controllers of the plurality of controllers cannot manipulate the resource while being leased to the first controller.

15. The method of claim 13, further comprising:
obtaining, by the one or more processors, a first lease for the first controller for manipulating a resource of the plurality of resources, the first lease including a first priority level;
breaking, by the one or more processors, the first lease held by the first controller, wherein another controller of the plurality of controllers holds a second lease for the resource with a second priority level higher than the first priority level.

16. The method of claim 13, further comprising:
generating, by the one or more processors, a conflict-resolving resource, the conflict-resolving resource including a resource, at least two requests to manipulate the resource from at least two of the plurality of controllers, and a priority level for each of the requests;
generating, by the one or more processors, a conflict-resolving controller, the conflict resolving controller configured to select a request among the requests with a highest priority level, manipulate the resource based on the selected request, and pass the manipulated resource to another controller of the plurality of controllers for actuation.

17. The method of claim 13, wherein the plurality of resources includes only one resource of a type to be used by the plurality of controllers of the robot, each of the resources includes a current action to be executed and identifies a controller of the plurality of controllers for execution.

18. The method of claim 1, further comprising:
monitoring, by the one or more processors, changes in the current states for the first controller and changes in the current states for the second controller;
generating, by the one or more processors, a log including in the current states for the first controller and changes in the current states for the second controller.

19. A system, comprising:
a plurality of processors in a distributed system including at least one processor on a cloud computing system and at least one processor on a robot, the plurality of processors configured to:
receive configuration data for a plurality of controllers of a robot, the configuration data including desired states for the plurality of controllers;
deploy the plurality of controllers on the distributed system, wherein a first controller of the plurality of controllers is deployed on one or more processors on the cloud computing system and a second controller of the plurality of controllers is deployed on one or more processors on the robot;
synchronize a cloud database on the cloud computing system with a robot database on the robot, the cloud database and the robot database store configuration data and current states of the first controller and configuration data and current states of the second controller;
control workload for the first controller based on the configuration data and the current states of the first controller and the configuration data and current states of the second controller; and
control workload for the second controller based on the configuration data and the current states of the first controller and the configuration data and the current states of the second controller.

20. A computer-readable storage medium storing instructions executable by one or more processors for performing a method, comprising:
receiving configuration data for a plurality of controllers of a robot, wherein the configuration data includes desired states for the plurality of controllers;
deploying the plurality of controllers on a distributed system, wherein a first controller of the plurality of controllers is deployed on one or more processors on a cloud computing system and a second controller of the plurality of controllers is deployed on one or more processors on the robot;
synchronizing a cloud database on the cloud computing system with a robot database on the robot, the cloud database and the robot database store configuration data and current states of the first controller and configuration data and current states of the second controller;
controlling workload for the first controller based on the configuration data and the current states of the first controller and the configuration data and current states of the second controller; and
controlling workload for the second controller based on the configuration data and the current states of the first controller and the configuration data and the current states of the second controller.
